(19) United States
(12) Patent Application Publication
(10) Pub. No.: US 2010/0174427 A1
(43) Pub. Date: Jul. 8, 2010

(54) SYSTEM AND METHOD FOR LIMITING IN-TRAIN FORCES OF A RAILROAD TRAIN

(76) Inventors: Manthram Sivasubramaniam, Bangalore (IN); David So Keung Chan, Niskayuna, NY (US); Paul K. Houpt, Schenectady, NY (US); Krishnamoorthy Kalyanam, Bangalore (IN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/348,552

(22) Filed: Jan. 5, 2009

(51) Int. Cl. G05D 1/00

(52) U.S. Cl. 701/19

(57) ABSTRACT

A system and method for determining and managing a slack state of a train and for is disclosed. The system acquires railway system parameters for a plurality of railway vehicles and for a track segment traversed by the plurality of railway vehicles, the parameters including a grade of the track segment at each of a plurality of locations therealong and an acceleration of each of the plurality of railway vehicles at each of the plurality of locations. The system calculates a coupler force for each of the plurality of railway vehicles at each of the plurality of locations based on the railway system parameters, determines a slack state for the plurality of railway vehicles based on the calculated coupler forces, and determines a limit on a tractive effort generated by locomotive consists included in the railway vehicles based on the determined slack state.

### BACKGROUND

1. Technical Field

The invention includes embodiments that relate to a train handling system. The invention includes embodiments that relate to a method of using the train handling system.

2. Discussion of Art

A locomotive is a complex system with numerous subsystems, each subsystem interdependent on other subsystems. An operator aboard a locomotive applies tractive and braking effort to control the speed of the locomotive and its load of railcars to assure proper operation and timely arrival at the desired destination. Speed control is also exercised to maintain in-train forces within acceptable limits, thereby avoiding excessive coupler forces and the possibility of a train break. To perform this function and comply with prescribed operating speeds that may vary with the train's location on the track, the operator generally must have extensive experience operating the locomotive over the specified terrain with different railcar consists.

Train control can also be exercised by an automatic train control system that determines various train and trip parameters, e.g., the timing and magnitude of tractive and braking applications to control the train. Alternatively, a train control system advises the operator of preferred train control actions, with the operator exercising train control in accordance with the advised actions or in accordance with his/her independent train control assessments.

The train's coupler slack condition (the distance between two linked couplers and changes in that distance) substantially affects train control. Certain train control actions are permitted if certain slack conditions are present, while other train control actions are undesired since they may lead to train, railcar, or coupler damage. If the slack condition of the train (or segments of the train) can be determined, predicted or inferred, proper train control actions can be executed responsive thereto, minimizing damage risks or a train break-up.

It would therefore be desirable to provide a system and method for determining a slack condition of the train. It would further be desirable to provide a system and method that determines setting and limits on train control actions for controlling the slack condition of the train.

### BRIEF DESCRIPTION

According to an aspect of the invention, a train handling apparatus includes a computer readable storage medium having a sequence of instructions stored thereon, which, when executed by a processor, causes the processor to acquire railway system parameters for a plurality of railway vehicles comprising a first group and a second group configured to drive the first group by way of a tractive effort and for a track segment traversed by the plurality of railway vehicles. The railway system parameters further include a grade of the track segment at each of a plurality of locations therealong and an acceleration of each of the plurality of railway vehicles at each of the plurality of locations. The sequence of instructions stored on the computer readable storage medium also causes the processor to calculate a coupler force for each of the plurality of railway vehicles at each of the plurality of locations based on the railway system parameters, determine a slack state for the plurality of railway vehicles based on the calculated coupler forces, and determine a limit for the tractive effort generated by the second group of railway vehicles based on the determined slack state.

In accordance with another aspect of the invention, a system includes a first plurality of vehicles and a second plurality of vehicles coupled to the first plurality of vehicles, with the second plurality of vehicles configured to provide tractive effort to move the first plurality of vehicles. The system also includes a computer having one or more processors programmed to receive a plurality of railway parameters for the first and second plurality of vehicles and for a track segment traversed by the first and second plurality of vehicles, the railway system parameters comprising a grade of the track segment at each of a plurality of locations there along and an acceleration of each of the plurality of vehicles at each of the plurality of locations. The processors are further programmed to determine a force balance present at each of the plurality of vehicles based on the plurality of railway parameters, determine a slack state for the plurality of vehicles based on the calculated coupler forces, and determine handling constraints for the second plurality of vehicles based on the determined slack state to manage the slack state for the first and second plurality of vehicles.

In accordance with another aspect of the invention, a method includes the step of receiving a plurality of railway system parameters for a plurality of railway vehicles and for a track segment traversed by the plurality of railway vehicles, the plurality of railway vehicles comprising a first group and a second group configured to drive the first group by way of a tractive effort. The method also includes the steps of generating a rope model of the plurality of railway vehicles from the plurality of railway system parameters and determining a slack state of the plurality of railway vehicles based on the rope model. The method further includes the steps of determining a limit for the tractive effort generated by the second group of railway vehicles based on the determined slack state and modifying a planned tractive effort to be generated by the second plurality of vehicles when traversing the track segment in order to manage the slack state for the first and second plurality of vehicles.

Various other features will be apparent from the following detailed description and the drawings.

### BRIEF DESCRIPTION OF THE DRAWINGS

The drawings illustrate an embodiment of the invention. For ease of illustration, a locomotive and track system has been identified, but other vehicles and vehicle routes are included except where language or context indicates otherwise.

FIGS. 1 and 2 graphically depict slack conditions of a railroad train.

FIG. 3 graphically depicts acceleration and deceleration limits based on the slack condition.

FIG. 4 illustrates multiple slack conditions associated with a railroad train.

FIG. 5 illustrates a block diagram of a system for determining a slack condition and controlling a train responsive thereto.

FIG. 6 is a flow diagram illustrating a technique for determining in-train forces and a slack condition and for controlling a train responsive thereto.

### DETAILED DESCRIPTION

The invention includes embodiments that relate to systems and methods of railroad train operations and more particularly to determining in-train forces and a slack state of the train. The invention also includes embodiments that relate to systems and methods for determining train handling settings that limit in-train forces.

According to one embodiment of the invention, a train handling apparatus includes a computer readable storage medium having a sequence of instructions stored thereon, which, when executed by a processor, causes the processor to acquire railway system parameters for a plurality of railway vehicles comprising a first group and a second group configured to drive the first group by way of a tractive effort and for a track segment traversed by the plurality of railway vehicles. The railway system parameters further include a grade of the track segment at each of a plurality of locations therealong and an acceleration of each of the plurality of railway vehicles at each of the plurality of locations. The sequence of instructions stored on the computer readable storage medium also causes the processor to calculate a coupler force for each of the plurality of railway vehicles at each of the plurality of locations based on the railway system parameters, determine a slack state for the plurality of railway vehicles based on the calculated coupler forces, and determine a limit for the tractive effort generated by the second group of railway vehicles based on the determined slack state.

In accordance with another embodiment of the invention, a system includes a first plurality of vehicles and a second plurality of vehicles coupled to the first plurality of vehicles, with the second plurality of vehicles configured to provide tractive effort to move the first plurality of vehicles. The system also includes a computer having one or more processors programmed to receive a plurality of railway parameters for the first and second plurality of vehicles and for a track segment traversed by the first and second plurality of vehicles, the railway system parameters comprising a grade of the track segment at each of a plurality of locations there along and an acceleration of each of the plurality of vehicles at each of the plurality of locations. The processors are further programmed to determine a force balance present at each of the plurality of vehicles based on the plurality of railway parameters, determine a slack state for the plurality of vehicles based on the calculated coupler forces, and determine handling constraints for the second plurality of vehicles based on the determined slack state to manage the slack state for the first and second plurality of vehicles.

In accordance with yet another embodiment of the invention, a method includes the step of receiving a plurality of railway system parameters for a plurality of railway vehicles and for a track segment traversed by the plurality of railway vehicles, the plurality of railway vehicles comprising a first group and a second group configured to drive the first group by way of a tractive effort. The method also includes the steps of generating a rope model of the plurality of railway vehicles from the plurality of railway system parameters and determining a slack state of the plurality of railway vehicles based on the rope model. The method further includes the steps of determining a limit for the tractive effort generated by the second group of railway vehicles based on the determined slack state and modifying a planned tractive effort to be generated by the second plurality of vehicles when traversing the track segment in order to manage the slack state for the first and second plurality of vehicles.

Reference will now be made in detail to the embodiments consistent with aspects of the invention, examples of which are illustrated in the accompanying drawings. Wherever possible, the same reference numerals used throughout the drawings refer to the same or like parts.

Embodiments of the present invention solve certain problems in the art by providing an apparatus, system, and method for limiting in-train forces for a railway system, including in various applications, a locomotive consist, a maintenance-of-way vehicle and a plurality of railcars. The present embodiments are also applicable to a train including a plurality of distributed locomotive consists, referred to as a distributed power train, typically including a lead consist and one or more non-lead consists.

Persons skilled in the art will recognize that an apparatus, such as a data processing system, including a CPU, memory, I/O, program storage, a connecting bus, and other appropriate components, could be programmed or otherwise designed to facilitate the practice of the method of the invention embodiments. Such a system would include appropriate program means for executing the methods of these embodiments.

In another embodiment, an article of manufacture, such as a pre-recorded disk or other similar computer program product, for use with a data processing system, includes a storage medium and a program recorded thereon for directing the data processing system to facilitate the practice of the method of the embodiments of the invention. Such apparatus and articles of manufacture also fall within the spirit and scope of the embodiments.

The disclosed invention embodiments teach methods, apparatuses, and systems for determining a slack condition and/or quantitative/qualitative in-train forces and for controlling the railway system responsive thereto to limit such in-train forces. To facilitate an understanding of the embodiments of the present invention they are described hereinafter with reference to specific implementations thereof.

According to one embodiment, the invention is described in the general context of computer-executable instructions, such as program modules, executed by a computer. Generally, program modules include routines, programs, objects, components, data structures, etc. that perform particular tasks or implement particular abstract data types. For example, the software programs that underlie the embodiments of the invention can be coded in different languages, for use with different processing platforms. It will be appreciated, however, that the principles that underlie the embodiments can be implemented with other types of computer software technologies as well.

Moreover, those skilled in the art will appreciate that the embodiments of the invention may be practiced with other computer system configurations, including hand-held devices, multiprocessor systems, microprocessor-based or programmable consumer electronics, minicomputers, mainframe computers, and the like. The embodiments of the invention may also be practiced in a distributed computing environment where tasks are performed by remote processing devices that are linked through a communications network. In the distributed computing environment, program modules may be located in both local and remote computer storage media including memory storage devices. These local and remote computing environments may be contained entirely within the locomotive, within other locomotives of the train, within associated railcars, or off-board in wayside or central offices where wireless communications are provided between the different computing environments.

The term “locomotive” can include (1) one locomotive or (2) multiple locomotives in succession (referred to as a locomotive consist), connected together so as to provide motoring and/or braking capability with no railcars between the locomotives. A train may comprise one or more such locomotive consists. Specifically, there may be a lead consist and one or more remote (or non-lead) consists, such as a first non-lead (remote) consist midway along the line of railcars and another remote consist at an end-of-train position. Each locomotive consist may have a first or lead locomotive and one or more trailing locomotives. Though a consist is usually considered connected successive locomotives, those skilled in the art recognize that a group of locomotives may also be consider a consist even with at least one railcar separating the locomotives, such as when the consist is configured for distributed power operation, wherein throttle and braking commands are relayed from the lead locomotive to the remote trails over a radio link or a physical cable. Towards this end, the term locomotive consist should be not be considered a limiting factor when discussing multiple locomotives within the same train.

Referring now to the drawings, embodiments of the present invention will be described. The various embodiments of the invention can be implemented in numerous ways, including as a system (including a computer processing system), a method (including a computerized method), an apparatus, a computer readable medium, a computer program product, a graphical user interface, including a web portal, or a data structure tangibly fixed in a computer readable memory. Several embodiments of the various invention embodiments are discussed below.

Two adjacent railroad railcars or locomotives are linked by a knuckle coupler attached to each railcar or locomotive. Generally, the knuckle coupler includes four elements: a cast steel coupler head, a hinged jaw or “knuckle” rotatable relative to the head, a hinge pin about which the knuckle rotates during the coupling or uncoupling process, and a locking pin. When the locking pin on either or both couplers is moved upwardly away from the coupler head the locked knuckle rotates into an open or released position, effectively uncoupling the two railcars/locomotives. Application of a separating force to either or both of the railcars/locomotives completes the uncoupling process.

When coupling two railcars, at least one of the knuckles must be in an open position to receive the jaw or knuckle of the other railcar. The two railcars are moved toward each other. When the couplers mate the jaw of the open coupler closes and responsive thereto the gravity-fed locking pin automatically drops in place to lock the jaw in the closed condition and thereby lock the couplers closed to link the two railcars.

Even when coupled and locked, the distance between the two linked railcars can increase or decrease due to the spring-like effect of the interaction of the two couplers and due to the open space between the mated jaws or knuckles. The distance by which the couplers can move apart when coupled is referred to as an elongation distance or coupler slack and can be as much as about four to six inches per coupler. A stretched “slack condition” occurs when the distance between two coupled railcars is about the maximum separation distance permitted by the slack of the two linked couplers. A bunched (compressed) condition occurs when the distance between two adjacent railcars is about the minimum separation distance as permitted by the slack between the two linked couplers.

As is known, a train operator (e.g., either a human train engineer with responsibility for operating the train, an automatic train control system that operates the train without or with minimal operator intervention or an advisory train control system that advises the operator to implement train control operations while allowing the operator to exercise independent judgment as to whether the train should be controlled as advised) increases the train's commanded horsepower/speed by moving a throttle handle to a higher notch position and decreases the horsepower/speed by moving the throttle handle to a lower notch position or by applying the train brakes (the locomotive dynamic brakes, the independent air brakes or the train air brakes). Any of these operator actions, as well as train dynamic forces and the track profile, can affect the train's overall slack condition and the slack condition between any two linked couplers.

When referred to herein, tractive effort (TE) further includes braking effort and braking effort further includes braking actions resulting from the application of the locomotive dynamic brakes, the locomotive independent brakes and the air brakes throughout the train.

The in-train forces that are managed by the application of tractive effort are referred to as draft forces (a pulling force or a tension) on the couplers and draft gear during a stretched slack state and referred to as buff forces during a bunched or compressed slack condition. A draft gear includes a force-absorbing element that transmits draft or buff forces between the coupler and the railcar to which the coupler is attached.

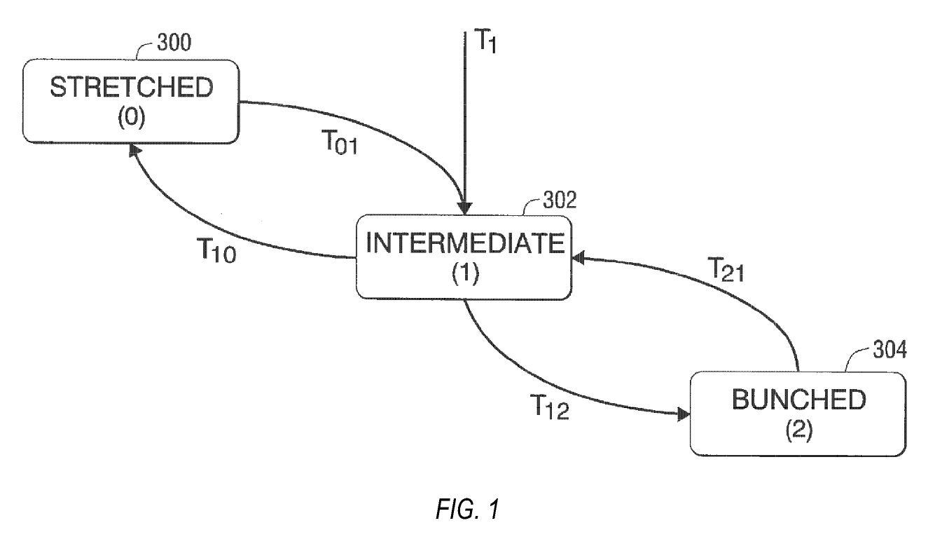

A FIG. 1 state diagram depicts three discrete slack states: a stretched state 300, an intermediate state 302 and a bunched state 304. Transitions between states, as described herein, are indicated by arrowheads referred to as transitions “T” with a subscript indicating a previous state and a new state.

State transitions are caused by the application of tractive effort (that tends to stretch the train), braking effort (that tends to bunch the train) or changes in terrain that can cause either a run-in or a run-out. The rate of train stretching (run-out) depends on the rate at which the tractive effort is applied as measured in horsepower/second or notch position change/second. For example, tractive effort is applied to move from the intermediate state (1) to the stretched state (0) along a transition T₁₀. For a distributed power train including remote locomotives spaced-apart from the lead locomotive in the train consist, the application of tractive effort at any locomotive tends to stretch the railcars following that locomotive (with reference to the direction of travel).

Generally, when the train is first powered up the initial coupler slack state is unknown. But as the train moves responsive to the application of tractive effort, the state is determinable. The transition T₁ into the intermediate state (1) depicts the power-up scenario.

The rate of train bunching (run-in) depends on the braking effort applied as determined by the application of the dynamic brakes, the locomotive independent brakes or the train air brakes.

The intermediate state 302 is not a desired state. The stretched state 300 is preferred, as train handling is easiest when the train is stretched, although the operator can accommodate a bunched state.

The FIG. 1 state machine can represent an entire train or train segments (e.g., the first 30% of the train in a distributed power train or a segment of the train bounded by two spaced-apart locomotive consists). Multiple independent state machines (i.e., train handling apparatuses) can each describe a different train segment, each state machine including multiple slack states such as indicated in FIG. 1. For example a distributed power train or pusher operation can be depicted by multiple state machines representing the multiple train segments, each segment defined, for example, by one of the locomotive consists within the train.

As an alternative to the discrete states representation of FIG. 1, FIG. 2 depicts a curve 318 representing a continuum of slack states from a stretched state through an intermediate state to a bunched state, each state generally indicated as shown. The FIG. 2 curve more accurately portrays the slack condition than the state diagram of FIG. 1, since there are no universal definitions for discrete stretched, intermediate and bunched states, as FIG. 1 might suggest. As used herein, the term slack condition refers to discrete slack states as illustrated in FIG. 1 or a continuum of slack states as illustrated in FIG. 2.

Like FIG. 1, the slack state representation of FIG. 2 can represent the slack state of the entire train or train segments. In one example the segments are bounded by locomotive consists and the end-of-train device. One train segment of particular interest includes the railcars immediately behind the lead consist where the total forces, including steady state and slack-induced transient forces, tend to be highest. Similarly, for a distributed power train, the particular segments of interest are those railcars immediately behind and immediately ahead of the non-lead locomotive consists.

To avoid coupler and train damage, the train's slack condition can be taken into consideration when applying TE or BE. The slack condition refers to one or more of a current slack condition, a change in slack condition from a prior time or track location to a current time or current track location and a current or real time slack transition (e.g., the train is currently experiencing a run-in or a run-out slack transition). The rate-of-change of a real time slack transition can also affect the application of TE and BE to ensure proper train operation and minimize damage potential.

The referred to TE and BE can be applied to the train by control elements/control functions, including, but not limited to, the operator by manual manipulation of control devices, automatically by an automatic control system or manually by the operator responsive to advisory control recommendations produced by an advisory control system. Typically, an automatic train control system or train handling apparatus implements train control actions (and an advisory control system suggests train control actions for consideration by the operator) to optimize a train performance parameter, such as fuel consumption.

Train characteristic parameters (e.g., railcar masses, acceleration, grade) for use by the apparatuses and methods described herein to determine the slack condition can be supplied by the train manifest or by other techniques known in the art. The operator can also supply train characteristic information, overriding or supplementing previously provided information, to determine the slack condition according to the embodiments of the invention. The operator can also input a slack condition for use by the control elements in applying TE and BE.

When a train is completely stretched, additional tractive effort can be applied at a relatively high rate in a direction to increase the train speed (i.e., a large acceleration) without damaging the couplers, since there will be little relative movement between linked couplers. Any such induced additional transient coupler forces are small beyond the expected steady-state forces that are due to increased tractive effort and track grade changes. But when in a stretched condition, a substantial reduction in tractive effort at the head end of the train, the application of excessive braking forces or the application of braking forces at an excessive rate can suddenly reduce the slack between linked couplers. The resulting forces exerted on the linked couplers can damage the couplers, causing the railcars to collide or derail the train.

As a substantially compressed train is stretched (referred to as run-out) by the application of tractive effort, the couplers linking two adjacent railcars move apart as the two railcars (or locomotives) move apart. As the train is stretching, relatively large transient forces are generated between the linked couplers as they transition from a bunched to a stretched state. In-train forces capable of damaging the coupling system or breaking the linked couplers can be produced even at relatively slow train speeds of one or two miles per hour. Thus if the train is not completely stretched it is necessary to limit the forces generated by the application of tractive effort during slack run-out.

When the train is completely bunched, additional braking effort (by operation of the locomotive dynamic brakes or independent brakes) or a reduction of the propulsion forces can be applied at a relatively high rate without damage to the couplers, draft gears or railcars. But the application of excessive tractive forces or the application of such forces at an excessive rate can generate high transient coupler forces that cause adjacent railcars to move apart quickly, changing the coupler's slack condition, leading to possible damage of the coupler, coupler system, draft gear or railcars.

As a substantially stretched train is compressed (referred to as run-in) by applying braking effort or reducing the train speed significantly by moving the throttle to a lower notch position, the couplers linking two adjacent cars move together. An excessive rate of coupler closure can damage the couplers, damage the railcars or derail the train. Thus if the train is not completely bunched it is necessary to limit the forces generated by the application of braking effort during the slack run-in period.

If the operator (e.g., automatic control system) knows the current slack condition, then the train can be controlled by commanding an appropriate level of tractive or braking effort to maintain or change the slack condition as desired. Braking the train tends to create slack run-in and accelerating the train tends to create slack run-out. For example, if a transition to the bunched condition is desired, the operator may switch to a lower notch position or apply braking effort at the head end to slow the train at a rate less than its natural acceleration. The natural acceleration is the acceleration of a railcar when no external forces (except gravity) are acting on it.

If slack run-in or run-out occurs without operator action, such as when the train is descending a hill, the operator can counter those effects, if desired, by appropriate application of higher tractive effort to counter a run-in or braking effort or lower tractive effort to counter a run-out.

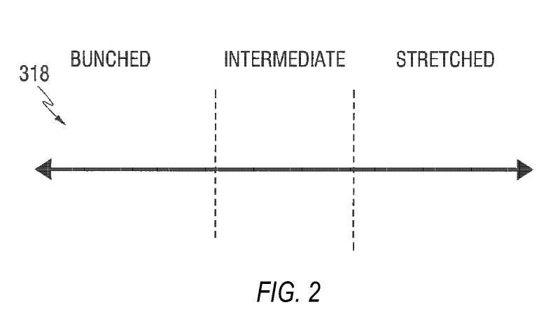

FIG. 3 graphically illustrates limits on the application of tractive effort (accelerating the train) and braking effort (decelerating the train) as a function of a slack state along the continuum of slack conditions between stretched and compressed. As the slack condition tends toward a compressed state, the range of acceptable acceleration forces decreases to avoid imposing excessive forces on the couplers, but acceptable decelerating forces increase. The opposite situation exists as the slack condition tends toward a stretched condition.

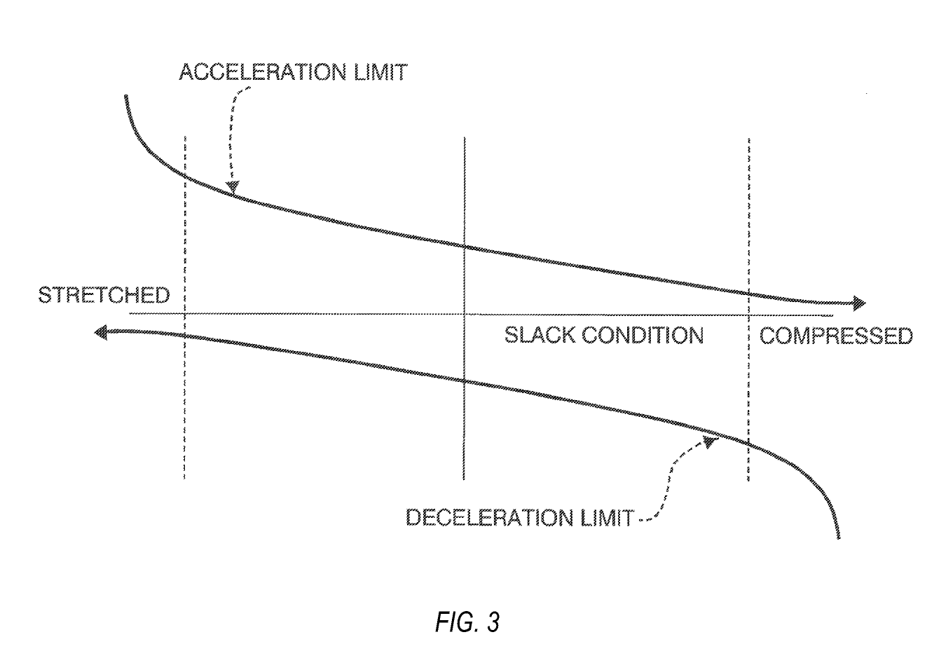

FIG. 4 illustrates train segment slack states for a train 400. Railcars 401 immediately behind a locomotive consist 402 are in a first slack state (SS1) and railcars 408 immediately behind a locomotive consist 404 are in a second slack state (SS2). An overall slack state (SS1 and SS2) encompassing the slack states SS1 and SS2 and the slack state of the locomotive consist 404, is also illustrated. The railcars 401 (and optionally railcars 408) can be generally designated as a first group or plurality of railcars within the train. The locomotive consist 402 (and optionally locomotive consist 404) can generally be designated as a second group or plurality of railcars within the train.

Designation of a discrete slack state as in FIG. 1 or a slack condition on the curve 318 of FIG. 2 includes a degree of uncertainty dependent on the methods employed to determine the slack state/condition and practical limitations associated with these methods.

One embodiment of the present invention determines, infers or predicts the slack condition for the entire train, i.e., substantially stretched, substantially bunched or in an intermediate slack state, including any number of intermediate discrete states or continuous states. The embodiments of the invention can also determine the slack condition for any segment of the train. The embodiments of the invention also detect (and provide the operator with pertinent information related thereto) a slack run-in (rapid slack condition change from stretched to bunched) and a slack run-out (rapid slack condition change from bunched to stretched), including run-in and run-out situations that may result in train damage. These methodologies are described below.

Responsive to the determined slack condition, the automated control system controls train handling to contain in-train forces that can damage the couplers and cause a train break when a coupler fails, while also maximizing train performance. To improve train operating efficiency, a higher deceleration rate can be applied when the train is bunched and, conversely, a higher acceleration rate can be applied when the train is stretched. However, irrespective of the slack condition, maximum predetermined acceleration and deceleration limits (i.e., the application of tractive effort and the corresponding speed increases and the application of braking effort and the corresponding speed decreases) should be enforced for proper train handling.

The input parameters from which the slack condition can be determined, inferred or predicted include, but are not limited to, distributed train weight, track profile, track grade, environmental conditions (e.g., rail friction, wind), applied tractive effort, applied braking effort, brake pipe pressure, historical tractive effort, historical braking effort, train speed/acceleration measured at each car within the train, and railcar characteristics. The time rate at which the slack condition is changing (a transient slack condition) or the rate at which the slack condition is moving through the train may also be related to one or more of these parameters.

The slack condition can also be determined, inferred or predicted from various train operational events, such as, the application of sand to the rails, isolation of locomotives and flange lube locations. Since the slack condition is not necessarily the same for all train railcars at each instant in time, the slack can be determined, inferred or predicted for individual railcars or for segments of railcars in the train.

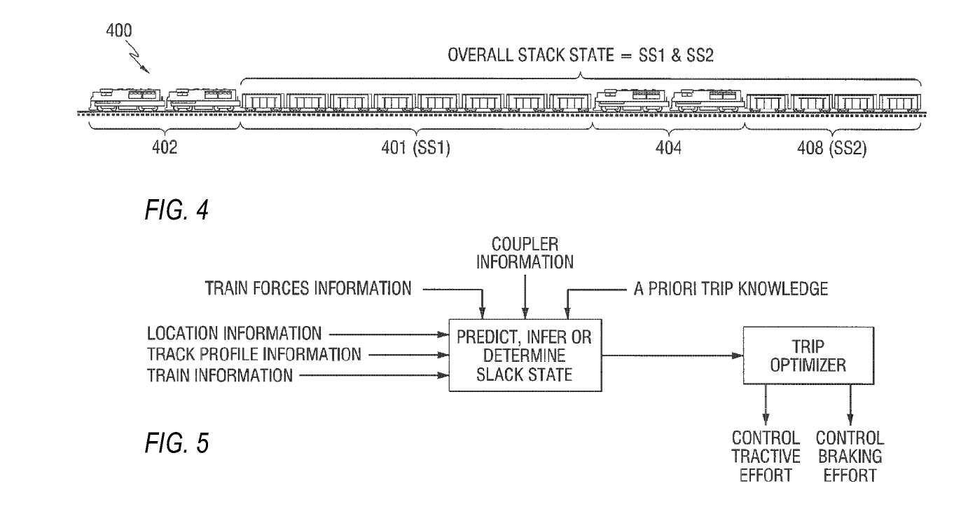

FIG. 5 generally indicates the information and various parameters that can be used according to the embodiments of the present invention to determine, infer or predict the slack condition, as well as determine tractive effort (and braking effort) limits/settings to be applied, for example, by the trip optimizer, as further described below. The train parameters can be comprised of a priori trip information that includes a trip plan (preferably an optimized trip plan) including a speed and/or power (traction effort (TE)/braking effort (BE)) trajectory for a segment of the train's trip over a known track segment, as well as grade information for the track segment and acceleration data for each railcar in the train during the train's trip. Assuming that the train follows the trip plan, the slack condition can be predicted or inferred at any point along the track to be traversed, either before the trip has begun or while en route, based on the planned upcoming brake and tractive effort applications and the physical characteristics of the train (e.g., mass, mass distribution, resistance forces) and the track.

In an exemplary application of one embodiment of the invention to a train control system (i.e., train handling apparatus) that plans a train trip and controls train movement to optimize train performance (based, for example, on determined, predicted, or inferred train characteristics and the track profile), the a priori information can be sufficient for determining the slack condition of the train for the entire train trip. The slack condition of the train can then be used to determine appropriate tractive effort settings for the course of trip, prior to departure of the train. According to another embodiment, it is recognized that tractive effort settings can be determined during the course of the trip along the track segment. That is, as real time operating parameters may be different during a trip than assumed in planning the trip a priori (e.g., the wind resistance encountered by the train may be greater than expected or the track friction may be less than assumed), it may be desirable to modify tractive effort and braking effort settings during traversing of the track segment. In such an application, the real time parameters are compared with the parameter values assumed in formulating the trip and, responsive to differences between the assumed parameter and the real time parameter, the TE/BE applications can be modified.

As further shown in FIG. 5, coupler information, including coupler types and the railcar type on which they are mounted, the maximum sustainable coupler forces and the coupler dead band, may also be used to determine, predict or infer the slack condition. In particular, this information may be used in determining thresholds for transferring from a first slack state to a second slack state, for selecting the rate-of-change of TE/BE applications and/or for determining acceptable acceleration limits. This information can be obtained from the train make-up or one can initially assume a coupler state and learn the coupler characteristics during the trip as described below.

The force calculations or predictions determined from the above train parameters can be limited to a plurality of cars in the front of the train where the application of tractive effort or braking effort can create the largest coupler forces due to the momentum of the trailing railcars. The forces can also be used to determine, predict or infer the current and future slack states for the entire train or for train segments.

According to an exemplary embodiment of the invention, a simplified rope model (i.e., rope model algorithm) is stored on a train handling apparatus computer or storage device and implemented thereby to describe and determine in-train forces and slack state conditions in the distributed train. The rope model assumes the same speed for all the locomotives and railcars, but makes use of the grade, resistance, and acceleration seen at each car to make out a force balance (i.e., coupler force) at each coupler in the train. Determination of the force balance at each coupler in the train allows for determination of slack state(s) in the train and of limits to be set on tractive and braking efforts in the train. While the embodiment described below sets forth the application of TE and the determination of TE limits, it is recognized that the following description is also applicable to determining BE application/limits in the train to limit in-train forces and manage the slack state.

In ultimately determining the force balance at each coupler by way of the rope model algorithm, the force balance of the distributed train can first be described as:

M\ddot{v}=TE−WR(v)−20 WG_{eff}(x) [Eqn. 1],

where M is the total weight of the train (lbs), \ddot{v} is the acceleration of the train, TE is the total tractive effort (lb) of the locomotive consists in the train, W is the total weight of the train (tons), R(v) is the drag of the train at a speed v, and G_{eff} is the effective grade (%) of the rail track over the length of the distributed train.

The force balance of the distributed train can, alternatively, be described as the sum of the forces of each unit/vehicle in the distributed train, according to:

$${\sum }_{i = 1}^{N} {m}_{i} \ddot{v} = {\sum }_{i = 1}^{M} {TE}_{i} - {\sum }_{i = 1}^{N} {w}_{i} {R}_{i} ( v ) - 20 {\sum }_{i = 1}^{N} {w}_{i} G ( x - ( i - 1 ) Δ x ) , \qquad [ Eqn . 2 ]$$

where N is the number of units/vehicles in the train, M is the number of locomotive consists, mᵢ is the weight (lbs) of the i^{th} unit, TEᵢ is the tractive effort (lb) of the i^{th} locomotive consist, wᵢ is the weight of the i^{th} unit (tons), Rᵢ(v) is the drag of the i^{th} unit at a speed v, and G is the grade (%) of the rail track at a location/distance x (corresponding to the i^{th} unit).

The force balance of the first unit, second unit, and each additional unit can thus be similarly described as:

m₁\ddot{v}=TE₁−w₁R₁(v)−20 w₁G(x)−F₁

m₂\ddot{v}=F ₁+TE₂−w₂R₂(v)−20 w₂G(x−Δx)−F₂

m₁\ddot{v}=Fᵢ₋₁−wᵢRᵢ(v)−20 wᵢG(x−(i−1)Δx)−Fᵢ [Eqn. 3]

where Δx describes the length of a railcar, and F₁, F₂, and Fᵢ are the coupler force at the end of the first, second, and i^{th} railcars, respectively.

Rearranging Eqns. 3-5, the coupler forces (F) present at the coupler at the end of, for example, the first, second, and i^{th} railcars can be determined by the rope model algorithm. That is, the coupler forces can be described according to:

$${F}_{1} = {TE}_{1} - {w}_{1} {R}_{1} ( v ) - 20 {w}_{1} G ( x ) - {m}_{1} \ddot{v} \\ {F}_{2} = {TE}_{1} + {TE}_{2} - {w}_{2} {R}_{2} ( v ) - 20 {w}_{2} G ( x - Δ x ) - {w}_{1} {R}_{1} ( v ) - 20 {w}_{1} G ( x ) - {m}_{2} \ddot{v} - {m}_{1} \ddot{v} \\ {F}_{i} = {\sum }_{j = 1}^{M} {TE}_{j} - {\sum }_{j = 1}^{i} {w}_{j} {R}_{j} ( v ) - 20 {\sum }_{j = 1}^{i} {w}_{j} G ( x ( j - 1 ) Δ x ) - {\sum }_{j = 1}^{i} {m}_{i} \ddot{v} . \qquad [ Eqn . 4 ]$$

As can be seen in Eqn. 4, in determining the coupler force present at any particular coupler, the acceleration (\ddot{v}) of each railcar is taken into account.

Incorporating Eqn. 2 into Eqn. 4, the coupler force at an i^{th} railcar coupler can be rewritten as:

$${F}_{i} = {\sum }_{j = 1}^{N} {TE}_{j} \frac{{\sum }_{j = i}^{N + M} {w}_{j}}{W} + \frac{20 {\sum }_{j = 1}^{N + M} {w}_{j} G ( x - ( j - 1 ) Δ x )}{W} {\sum }_{j = 1}^{i} {w}_{j} - 20 {\sum }_{j = 1}^{i} {w}_{j} G ( x - ( j - 1 ) Δ x ) . \qquad [ Eqn . 5 ]$$

In handling the train, it is desirable to maintain the coupler force present at each railcar below a certain threshold limit. That is, as a coupler force exceeding the threshold limit could cause damage to a coupler element, it is beneficial to limit the maximum coupler force acting on each of the coupler elements in the train. To limit the coupler forces, the tractive effort (TE) generated by the locomotive consists of the train can be limited, thereby reducing the coupler forces. Thus, by setting/determining a maximum allowable coupler force (Fₘₐₓ), a tractive effort limit (i.e., maximum tractive effort) can be determined to keep coupler forces below the maximum allowable coupler force. By rearranging Eqn. 5, the TE variable can be isolated to determine the tractive effort limit, as shown by:

$$TE \leq \frac{W}{{\sum }_{i = n + 1}^{M} {w}_{i}} {min}_{N < n < M} [ {F}_{max} - 20 ( \frac{1}{W} {\sum }_{i = 1}^{m} {w}_{i} {\sum }_{i = 1}^{M} {w}_{i} G ( x - ( i - 1 ) Δ x ) - {\sum }_{i = 1}^{m} {w}_{i} G ( x - ( i - 1 ) Δ x ) ) ] \\ \\ N < m < M . \qquad [ Eqn . 6 ]$$

In addition to analyzing the magnitude of the force balance/coupler force present at each railcar to determine tractive effort limits, the sign of the coupler force can also be analyzed to determine the type of forces (i.e., tension or compression) acting on a particular railcar. That is, if the force balance is positive (+) in value, the particular car is in tension and, if the force balance is negative (−) in value, the particular car is in compression. The magnitude of the coupler force present at the coupler of each railcar thus describes the amount of tension (if the force balance is positive) or compression (if the force balance is negative) in that particular coupler.

The sign and magnitude of each force balance is analyzed to determine a slack state of a particular section of the train (e.g., a section of railcars between two locomotive consists) or of the overall train. That is, the positive or negative force balance at each railcar coupler provides a “slack state flag” that indicates whether that particular coupler is contributing to stretching or bunching of the train. The slack state flags for the couplers in a section of the train, or for the entire train, can then be examined to determine the slack state. For example, if less than a certain pre-determined percentage, such as <5%, of the railcars in a section of the train have a negative force balance (i.e., are in compression) with the rest of the railcars having a positive force balance, then that section of the train is determined to be in a stretched slack state. If between 5% and 95% of the railcars in the section of the train have a negative force balance (i.e., are in compression) with the rest of the railcars having a positive force balance, then that section of the train is determined to be in an intermediate slack state. If greater than 95% of the railcars in the section of the train have a negative force balance (i.e., are in compression) with the rest of the railcars having a positive force balance, then that section of the train is determined to be in a bunched slack state.

By accurately determining the slack state of a particular section of the train (or of the entire train), an optimal plan for the TE generated by the locomotive consist(s) can be determined. As set forth above, it may be desirable to maintain the train in a stretched state, such that additional tractive effort can be applied at a relatively high rate in a direction to increase the train speed (i.e., a large acceleration) without damaging the couplers, since there will be little relative movement between linked couplers. Thus, based on the determined slack state of the train, an optimal plan for the TE generated by the locomotive consist(s) is determined and limits on the TE generated can be set in order to maintain or place the train in a stretched state.

According to an embodiment of the invention, in addition to determining the force balance present at couplers in the train, the rope model algorithm also allows for determining a rate-of-change of the force balance at any particular coupler in the train. The rate-of-change of the force balance is indicative of a rapid acceleration or deceleration of a particular railcar in the train (i.e., a high rate-of-change of the acceleration), which can lead to an excessive force build-up and possible derailment. The rate-of-change of the force balance can be determined by the rope model algorithm by taking the derivative of the force balance as set forth in Eqn. 5. The rate-of-change of the force balance is thus described by:

$${\dot{F}}_{i} = {\sum }_{j = 1}^{N} T {\dot{E}}_{j} \frac{{\sum }_{j = i}^{N + M} {w}_{j}}{W} + \frac{20 {\sum }_{j = 1}^{N + M} {w}_{j} \dot{G} ( x - ( j - 1 ) Δ x )}{W} v {\sum }_{j = 1}^{i} {w}_{j} - v 20 {\sum }_{j = 1}^{i} {w}_{j} \dot{G} ( x - ( j - 1 ) Δ x ) , \qquad [ Eqn . 7 ]$$

where \dot{F} is the rate-of-change of the force balance, TĖ is the rate-of-change of the tractive effort, and Ġ is the rate-of-change of the grade.

Similar to the desire to control the magnitude of the force balance present at couplers in the train, it is also desirable to control the rate-of-change of the coupler force present at each railcar, such that it is maintained below a certain threshold limit. The rate-of-change of the coupler force present at each railcar can be indicative of a run-in or run-out condition in the train, where a rapid change of slack condition from stretched to bunched or bunched to stretched occurs. That is, a high rate-of-change of the force balance in a positive direction can be indicative of an increase in tension/stretching and of a possible run-out condition, whereas a high rate-of-change of the force balance in a negative direction can be indicative of an increase in compression/bunching and of a possible run-in condition, as each of these occurrences indicates a high rate-of-change of the acceleration (i.e., jerk) in the train. To diagnose a run-in or run-out condition in the train (or a section of the train), the rate-of-change of the force balance at the couplers as well as the slack state flag for each force balance (i.e., positive or negative) is analyzed to allow for the determination of a run-in or run-out condition. The determined rate-of-change of the force balance for a group of specified couplers is compared to an ideal threshold rate-of-change of the force balance and, if the determined rate-of-change of the force balance is above the ideal/pre-determined threshold and the slack state flag changes from positive to negative or negative to positive, the train is determined to be in a run-in or run-out condition.

In order to prevent run-ins and run-outs from occurring in the train, a rate-of-change limit for the tractive effort generated by the locomotive consists can be set. Similar to the maximum tractive effort limitation determined in Eqn. 6, a maximum rate-of-change limit for the tractive effort can be determined according to:

$$T \dot{E} \leq \frac{W}{{\sum }_{i = n + 1}^{M} {w}_{i}} {min}_{N < n < M} [ {\dot{F}}_{max} - 20 ( \frac{1}{W} {\sum }_{i = 1}^{m} {w}_{i} {\sum }_{i = 1}^{M} {w}_{i} \dot{G} ( x - ( i - 1 ) Δ x ) - {\sum }_{i = 1}^{m} {w}_{i} \dot{G} ( x - ( i - 1 ) Δ x ) ) ] \\ \\ N < m < M . \qquad [ Eqn . 8 ]$$

According to one embodiment of the invention, the rate-of-change of the tractive effort is controlled by change in a notch position. Thus, an allowable notch position change per second is determined in order to maintain the rate-of-change limit for the tractive effort within the tractive effort rate-of-change limit.

The determination of the force balance at each coupler and of the rate-of-change of the force balance allows for an identification of regions-of-interest in the track segment to be traversed by the train. That is, sections of (or locations along) the track segment where the force balance or the rate-of-change of the force balance is determined to be above the force balance threshold or force balance rate-of-change threshold can be highlighted/identified as potential regions-of-interest. These regions-of-interest may be sections of the track segment having a steep grade, such as sags or crests in the track segment that might cause rapid acceleration/deceleration of the train, or may be other rough terrain that impacts the force balance on couplers within the train.

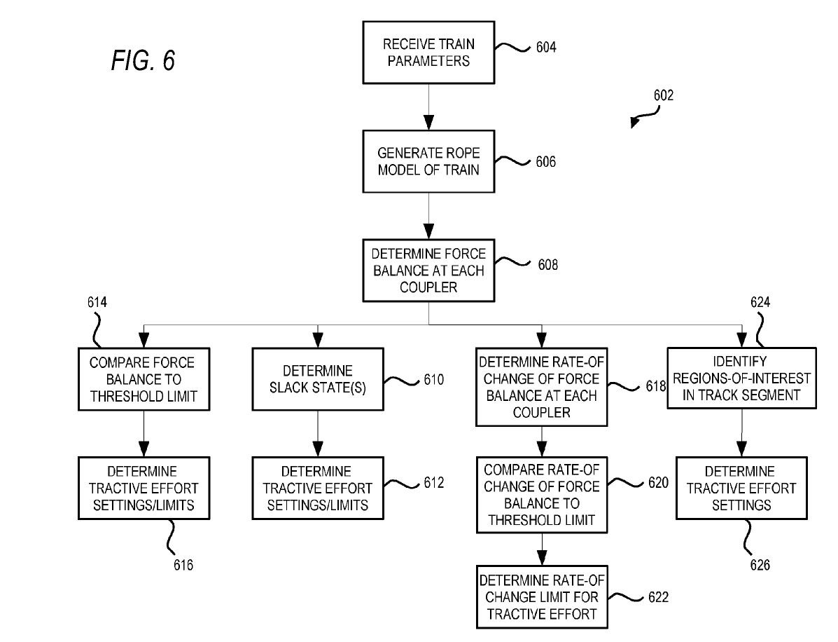

Referring now to FIG. 6, a technique 602 is set forth for determining in-train forces and for determining train handling constraints for limiting the in-train forces. According to an embodiment of the invention, the technique is a computer implemented technique performed by a train handling apparatus or control system. The train handling apparatus or control system includes a processor having stored thereon a rope model algorithm that models the train and determines in-train forces for the train based on a plurality of train parameters.

The technique begins at STEP 604, where a plurality of train parameters is received. The train parameters include parameters descriptive of the plurality of railcars in the train, as well as parameters descriptive of track segment to be traversed by the train according to a planned route/trip. According to an embodiment of the invention, the train parameters include a priori and planned information therein. That is, the train parameters can include a priori information on a grade of the track segment at each of a plurality of locations therealong, as well as other track related parameters (e.g., track roughness) based on a previous trip or passing of the train over that track segment. The planned train parameters can be input based on planned settings of the train for the trip along the track segment. These settings can be determined, for example, by a trip optimizer configured to generate a trip plan for the train to traverse the track segment that minimizes total energy expended. For example, a trip optimizer such as that set forth in U.S. patent application Ser. No. 11/385,354 to Ajith Kumar et al. The planned trip parameters can include a planned tractive effort to be generated by the locomotive consist(s) of the train, the number of locomotive consist(s), a railcar drag, a railcar/locomotive weight, and the number of railcars in the train. Additionally, an acceleration of each of the plurality of railcars and locomotive consists at each of a plurality of locations along the track segment is determined and included in the received train parameters.

Upon receipt of the train parameters, a rope model algorithm of the train is generated at STEP 606 that models the train as a distributed mass system. The rope model algorithm receives the train parameters as inputs in order to determine the in-train forces acting on the train according to the planned train handling parameter settings set forth by the trip optimizer. Based on the inputs, the rope model algorithm determines a force balance or coupler force present at the coupler between each pair of railcars in the train at STEP 608. That is, the force balance at each coupler is determined for each of a plurality of locations along the track segment. Beneficially, the inclusion of the acceleration of each of the railcars and locomotive consists in the rope model, for determining the force balance in the couplers at each of the plurality of locations along the track segment, allows for an accurate determination of the forces acting on the couplers.

Upon determining the force balance for each coupler, a slack state of the train is determined at STEP 610. The slack state can be determined for a particular section of the train (e.g., a section of the train between locomotive consists) or can be determined for the entire train. In determining the slack state of the train, or a portion thereof, the sign of the coupler force (i.e., positive (+) or negative (−)) is analyzed to determine the type of forces acting on a particular railcar. That is, if the force balance is positive (+) in value, the particular car is in tension and, if the force balance is negative (−) in value, the particular car is in compression. The sign and magnitude of each force balance is analyzed to determine a slack state of a particular section of the train (e.g., a section of railcars between two locomotive consists) or of the overall train. That is, the positive or negative force balance at each railcar coupler provides a “slack state flag” that indicates whether that particular coupler is contributing to stretching or bunching of the train. The slack state flags for the couplers in a section of the train, or for the entire train, can then be examined to determine the slack state.

Based on the slack state flag for each coupler in the identified section of the train (or the entire train), tractive effort settings and/or limits are determined at STEP 612 that manage the slack state in a desired manner. For example, tractive effort settings/limits may be determined that maintain the train in a stretched state, such that additional tractive effort can be applied at a relatively high rate in a direction to increase the train speed (i.e., a large acceleration) without damaging the couplers. Alternatively, tractive effort settings/limits may be determined that transition or change the slack condition from the stretched condition to the bunched condition, such as by applying a lower tractive effort at the lead locomotive consist that gradually slows the train at a rate less than its natural acceleration.

In addition to using the force balance at the couplers to determine the slack state of the train, the force balance at the couplers can also be analyzed to determine if any coupler force generated by the planned train parameters is above a pre-determined limit or threshold. That is, according to an embodiment of the invention, the calculated force balance for each coupler (at each location) is compared to a maximum allowable force balance for a coupler at STEP 614. Based on this comparison of the calculated force balance for each coupler (at each location) to the pre-determined force balance threshold limit, settings/limits for the tractive effort generated by the locomotive consists are determined at STEP 616 that function to keep the force balance for each coupler below the threshold limit. That is, a maximum amount of tractive effort that can be generated by the locomotive consists that keeps the force balance below the threshold limit is determined for each location along the track segment.

According to an embodiment of the invention, the rope model algorithm also determines a rate-of-change of the force balance for each coupler at STEP 618. The calculation of the force balance at each coupler for each of a plurality of locations along the track segment allows for the rate-of-change of the force balance for each coupler to be determined. The rate-of-change of the force balance is compared to a threshold rate-of-change of the force balance at STEP 620 in order to detect a run-in or run-out condition in the train. That is, a rate-of-change of the coupler force present at each railcar above a certain threshold limit can be indicative of a run-in or run-out condition in the train, as a high rate-of-change of the force balance in a positive direction can be indicative of an increase in tension/stretching and of a possible run-out condition and a high rate-of-change of the force balance in a negative direction can be indicative of an increase in compression/bunching and of a possible run-in condition. To diagnose a run-in or run-out condition in the train (or a section of the train), the rate-of-change of the force balance at the couplers as well as the slack state flag for each force balance (i.e., positive or negative) is analyzed. Based on the comparison of the rate-of-change of the force balance to the force balance rate-of-change threshold, a rate-of-change limit for the tractive effort generated by the locomotive consists is determined at STEP 622. The determined rate-of-change limit of the tractive effort can then be translated into an allowable notch position change per second during train operation.

According to an embodiment of the invention, the technique 602 also identifies regions-of-interest in the track segment at STEP 624. The regions-of-interest in the track segment can be identified based on the grade information of the track segment that is included in the received train parameters, as well as based on the force balance at each coupler and of the rate-of-change of the force balance. That is, sections of (or locations along) the track segment where the force balance or the rate-of-change of the force balance is determined to be above the force balance threshold or force balance rate-of-change threshold can be highlighted/identified as potential regions-of-interest. These regions-of-interest may be sections of the track segment having a steep grade, such as sags or crests in the track segment that might cause rapid acceleration/deceleration of the train, or may be other rough terrain that impacts the force balance on couplers within the train.

Based on an identification of regions-of-interest in the track segment, settings/limits for the tractive effort generated by the locomotive consists are determined at STEP 626 for controlling tractive effort generation by the locomotive consists at those locations along the track segment. Thus, for example, notch settings can be determined for traversing the regions-of-interest that allow for minimization of the force balance and rate-of-change of the force balance at each coupler in the train.

While the technique 602 set forth above is described as being implemented for determining settings prior to trip departure, it is also recognized that the technique could be performed online during operation of the train. That is, it is recognized that train parameters could be acquired during traversal of the train on the track segment and those parameters put into the rope model algorithm to determine desired modifications to the TE and BE settings so as to control in-train forces and the slack state of the train.

A technical contribution for the disclosed method and apparatus is that it provides for a computer configured to determine in-train forces and a slack state of the train and further determine train handling settings that limit in-train forces and manage the slack state.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not limited by the foregoing description, but is only limited by the scope of the appended claims.

What is claimed is:

1. A train handling apparatus comprising:
a computer readable storage medium having a sequence of instructions stored thereon, which, when executed by a processor, causes the processor to:
acquire railway system parameters for a plurality of railway vehicles comprising a first group and a second group configured to drive the first group by way of a tractive effort and for a track segment traversed by the plurality of railway vehicles, the railway system parameters comprising:
a grade of the track segment at each of a plurality of locations therealong; and
an acceleration of each of the plurality of railway vehicles at each of the plurality of locations;
calculate a coupler force for each of the plurality of railway vehicles at each of the plurality of locations based on the railway system parameters;
determine a slack state for the plurality of railway vehicles based on the calculated coupler forces; and
determine a limit for the tractive effort generated by the second group of railway vehicles based on the determined slack state.

2. The train handling apparatus of claim 1 wherein the sequence of instructions further causes the processor to:
generate a trip plan for the plurality of railway vehicles to traverse the track segment to minimize total energy expended, the trip plan comprising a planned tractive effort for the second group of railway vehicles; and
modify the planned tractive effort if the planned tractive effort is greater than the determined tractive effort limit.

3. The train handling apparatus of claim 1 wherein the railway system parameters further comprise a planned tractive effort, a railway vehicle drag, a railway vehicle weight, a number of railway vehicles in the first group, and a number of railway vehicles in the second group.

4. The train handling apparatus of claim 1 wherein the sequence of instructions further causes the processor to calculate the coupler force for each of the plurality of railway vehicles according to:
$${F}_{i} = {\sum }_{j = 1}^{N} {TE}_{j} \frac{{\sum }_{j = i}^{N + M} {w}_{j}}{W} + \frac{20 {\sum }_{j = 1}^{N + M} {w}_{j} G ( x - ( j - 1 ) Δ x )}{W} {\sum }_{j = 1}^{i} {w}_{j} - 20 {\sum }_{j = 1}^{i} {w}_{j} G ( x - ( j - 1 ) Δ x ) .$$

5. The train handling apparatus of claim 1 wherein the sequence of instructions further causes the processor to:
calculate a rate-of-change of the coupler force for each of the plurality of railway vehicles; and
determine a rate-of-change limit for the tractive effort generated by the second group of railway vehicles based on the calculated rate-of-change of the coupler force.

6. The train handling apparatus of claim 5 wherein the sequence of instructions further causes the processor to calculate the rate-of-change of the coupler force for each of the plurality of railway vehicles according to:
$${\dot{F}}_{i} = {\sum }_{j = 1}^{N} T {\dot{E}}_{j} \frac{{\sum }_{j = i}^{N + M} {w}_{j}}{W} + \frac{20 {\sum }_{j = 1}^{N + M} {w}_{j} \dot{G} ( x - ( j - 1 ) Δ x )}{W} v {\sum }_{j = 1}^{i} {w}_{j} - v 20 {\sum }_{j = 1}^{i} {w}_{j} \dot{G} ( x - ( j - 1 ) Δ x ) .$$

7. The train handling apparatus of claim 5 wherein the sequence of instructions further causes the processor to identify one of a run-in condition and a run-out condition for the plurality of railway vehicles based on the determined slack state and the calculated rate-of-change of the coupler force for each of the plurality of railway vehicles.

8. The train handling apparatus of claim 5 wherein the sequence of instructions further causes the processor to determine a notch position change per second for the second group of railway vehicles to maintain the rate-of-change limit for the tractive effort within the tractive effort rate-of-change limit.

9. The train handling apparatus of claim 1 wherein the sequence of instructions further causes the processor to identify regions-of-interest in the track segment, the regions-of-interest comprising locations along the track segment where a value of at least one of the calculated coupler forces and the calculated rate-of-change of the coupler forces is above a pre-determined threshold.

10. The train handling apparatus of claim 1 wherein the sequence of instructions further causes the processor to determine a limit for a braking effort applied by the second group of railway vehicles based on the determined slack state.

11. The train handling apparatus of claim 1 wherein the sequence of instructions is executed by the processor before traversing of the track segment by the plurality of railway vehicles or during traversal of the track segment by the plurality of railway vehicles.

12. The train handling apparatus of claim 11 wherein, when the sequence of instructions are executed by the processor before traversing of the track segment by the plurality of railway vehicles, the plurality of railway parameters comprise railway parameters measured from a previous pass of the first and second plurality of vehicles along the track segment.

13. A system comprising:
a first plurality of vehicles;
a second plurality of vehicles coupled to the first plurality of vehicles, the second plurality of vehicles configured to provide tractive effort to move the first plurality of vehicles; and
a computer having one or more processors programmed to:
receive a plurality of railway parameters for the first and second plurality of vehicles and for a track segment traversed by the first and second plurality of vehicles, the railway system parameters comprising a grade of the track segment at each of a plurality of locations there along and an acceleration of each of the plurality of vehicles at each of the plurality of locations;
determine a force balance present at each of the plurality of vehicles based on the plurality of railway parameters;
determine a slack state for the plurality of vehicles based on the calculated coupler forces; and
determine handling constraints for the second plurality of vehicles based on the determined slack state to manage the slack state for the first and second plurality of vehicles.

14. The system of claim 13 wherein the plurality of railway parameters further comprise a planned tractive effort, a vehicle drag, a vehicle weight, a number of railway vehicles in the first plurality of vehicles, and a number of railway vehicles in the second plurality of vehicles.

15. The system of claim 13 wherein the plurality of railway parameters comprise railway parameters measured from a previous pass of the first and second plurality of vehicles along the track segment.

16. The system of claim 13 wherein the one or more processors are further programmed to:
input the plurality of railway parameters into a rope model modeling the first and second plurality of vehicles; and
determine the force balance present at each of the plurality of vehicles using the rope model of the first and second plurality of vehicles.

17. The system of claim 13 wherein the one or more processors are further programmed to:
determine a rate-of-change of the force balance present at each of the plurality of vehicles; and
identify one of a run-in condition and a run-out condition for the plurality of vehicles based on the determined slack state and the calculated rate-of-change of the force balance for each of the plurality of vehicles.

18. The system of claim 17 wherein the one or more processors are further programmed to determine a rate-of-change limit for the tractive effort generated by the second group of railway vehicles based on the determined rate-of-change of the force balance.

19. The system of claim 17 wherein the one or more processors are further programmed to identify regions-of-interest in the track segment, the regions-of-interest comprising locations along the track segment where a value of at least one of the force balance and the calculated rate-of-change of the force balance is above a pre-determined threshold.

20. A method comprising:
receiving a plurality of railway system parameters for a plurality of railway vehicles and for a track segment traversed by the plurality of railway vehicles, the plurality of railway vehicles comprising a first group and a second group configured to drive the first group by way of a tractive effort;
generating a rope model of the plurality of railway vehicles from the plurality of railway system parameters;
determining a slack state of the plurality of railway vehicles based on the rope model;
determining a limit for the tractive effort generated by the second group of railway vehicles based on the determined slack state; and
modifying a planned tractive effort to be generated by the second plurality of vehicles when traversing the track segment in order to manage the slack state for the first and second plurality of vehicles.

21. The method of claim 20 wherein the plurality of railway system parameters comprises a grade of the track segment at each of a plurality of locations there along and an acceleration of each of the plurality of railway vehicles at each of the plurality of locations.

22. The method of claim 20 further comprising:
calculating a coupler force for each of the plurality of railway vehicles at each of the plurality of locations based on the railway system parameters;
calculating a rate-of-change of the coupler force for each of the plurality of railway vehicles.

23. The method of claim 22 further comprising:
determining a rate-of-change of the coupler force for each of the plurality of railway vehicles; and
determining a rate-of-change limit for the tractive effort generated by the second group of railway vehicles based on the determined rate-of-change of the coupler force for each of the plurality of railway vehicles.

24. The method of claim 23 further comprising identifying one of a run-in condition and a run-out condition for the plurality of vehicles based on the determined slack state and the determined rate-of-change of the coupler force for each of the plurality of vehicles

25. The method of claim 23 further comprising identifying regions-of-interest in the track segment, the regions-of-interest comprising locations along the track segment where a value of at least one of the coupler force and the rate-of-change of the coupler force is above a pre-determined threshold.
